(19) United States
(12) Patent Application Publication
(10) Pub. No.: US 2013/0091074 A1
(43) Pub. Date: Apr. 11, 2013

(54) METHOD AND SYSTEM FOR GENERATING A MUTUAL FUND SALES COVERAGE MODEL

(71) Applicant: ANNA RUTH TURNER, ETOBICOKE (CA)

(72) Inventor: ANNA RUTH TURNER, ETOBICOKE (CA)

(21) Appl. No.: 13/645,601

(22) Filed: Oct. 5, 2012

Related U.S. Application Data
(60) Provisional application No. 61/543,916, filed on Oct. 6, 2011.

(51) Int. Cl. G06Q 40/06

(52) U.S. Cl. 705/36 R

(57) ABSTRACT

A method for generating a sales coverage model for a purchaser of a mutual fund, comprising: using a processor, determining a purchaser score for the purchaser, the purchaser score being a predicted purchase amount of the mutual fund by the purchaser for an upcoming month; determining a responsiveness metric for the purchaser; determining a response curve for the purchaser by combining the purchaser score with a natural logarithm of a number of meetings with the purchaser per year scaled by the responsiveness metric and with a natural logarithm of a number of telephone calls to the purchaser per year scaled by the responsiveness metric, the response curve being a model of predicted purchase amount of the mutual fund by the purchaser for an upcoming year; determining a profit maximizing number of meetings with the purchaser and a profit maximizing number of telephone calls to the purchaser from the response curve and from predetermined costs associated with each meeting with the purchaser and with each telephone call to the purchaser; and, presenting the profit maximizing number of meetings with the purchaser and the profit maximizing number of telephone calls to the purchaser on a display coupled to the processor as the sales coverage model for the purchaser.

This application claims priority from U.S. Provisional Patent Application No. 61/543,916, filed Oct. 6, 2011, and incorporated herein by reference.

### FIELD OF THE INVENTION

This invention relates to the field of data mining, and more specifically, to a method and system for generating a mutual fund sales coverage model using data mining tools.

### BACKGROUND OF THE INVENTION

A mutual fund company distributes its products (i.e., mutual funds) to investors through financial advisors. Thus, in the mutual fund industry, a mutual fund company's customers are financial advisors who buy mutual funds on behalf of investors or consumers. Contact channels used in the mutual fund industry for selling mutual funds to advisors typically include face-to-face meetings, telephone calls, direct mail, and email.

One problem mutual fund companies have pertains to sales coverage, that is, the allocating of scarce sales resources to existing customers and prospective customers in order to maximize revenue or profit. Mutual fund companies need to identify advisors that are most likely to buy their funds in the near future allowing the mutual fund company's sales team to target and contact these identified advisors at the right time. The identification of these advisors and the timing of when they should be contacted represents a mutual fund sales coverage model or plan.

A need therefore exists for an improved method and system for generating a mutual fund sales coverage model. Accordingly, a solution that addresses, at least in part, the above and other shortcomings is desired.

### SUMMARY OF THE INVENTION

According to one aspect of the invention, there is provided a method for generating a sales coverage model for a purchaser of a mutual fund, comprising: using a processor, determining a purchaser score for the purchaser, the purchaser score being a predicted purchase amount of the mutual fund by the purchaser for an upcoming month; determining a responsiveness metric for the purchaser; determining a response curve for the purchaser by combining the purchaser score with a natural logarithm of a number of meetings with the purchaser per year scaled by the responsiveness metric and with a natural logarithm of a number of telephone calls to the purchaser per year scaled by the responsiveness metric, the response curve being a model of predicted purchase amount of the mutual fund by the purchaser for an upcoming year; determining a profit maximizing number of meetings with the purchaser and a profit maximizing number of telephone calls to the purchaser from the response curve and from predetermined costs associated with each meeting with the purchaser and with each telephone call to the purchaser; and, presenting the profit maximizing number of meetings with the purchaser and the profit maximizing number of telephone calls to the purchaser on a display coupled to the processor as the sales coverage model for the purchaser.

In accordance with further aspects of the present invention there is provided an apparatus such as a data processing system or a wireless device, a method for adapting these, as well as articles of manufacture such as a computer readable medium or product having program instructions recorded thereon for practising the method of the invention.

### BRIEF DESCRIPTION OF THE DRAWINGS

Further features and advantages of the embodiments of the present invention will become apparent from the following detailed description, taken in combination with the appended drawings, in which:

FIG. 1 is a block diagram illustrating a data processing system in accordance with an embodiment of the invention;

FIG. 2 is a block diagram illustrating timing for a first stage response curve in accordance with an embodiment of the invention;

FIG. 3 is a block diagram illustrating timing for a second stage response curve in accordance with an embodiment of the invention;

FIG. 4 is a graph illustrating an exemplary second stage response curve in accordance with an embodiment of the invention;

FIG. 5 is a graph illustrating an exemplary third stage response curve in accordance with an embodiment of the invention;

FIG. 6 is a table listing exemplary responsiveness metrics in accordance with an embodiment of the invention; and,

FIG. 7 is a flow chart illustrating operations of modules within a data processing system for generating a sales coverage model for a purchaser of a mutual fund, in accordance with an embodiment of the invention.

It will be noted that throughout the appended drawings, like features are identified by like reference numerals.

### DETAILED DESCRIPTION OF THE PREFERRED EMBODIMENTS

In the following description, details are set forth to provide an understanding of the invention. In some instances, certain software, circuits, structures and methods have not been described or shown in detail in order not to obscure the invention. The term “data processing system” is used herein to refer to any machine for processing data, including the computer systems, wireless devices, and network arrangements described herein. The present invention may be implemented in any computer programming language provided that the operating system of the data processing system provides the facilities that may support the requirements of the present invention. Any limitations presented would be a result of a particular type of operating system or computer programming language and would not be a limitation of the present invention. The present invention may also be implemented in hardware or in a combination of hardware and software.

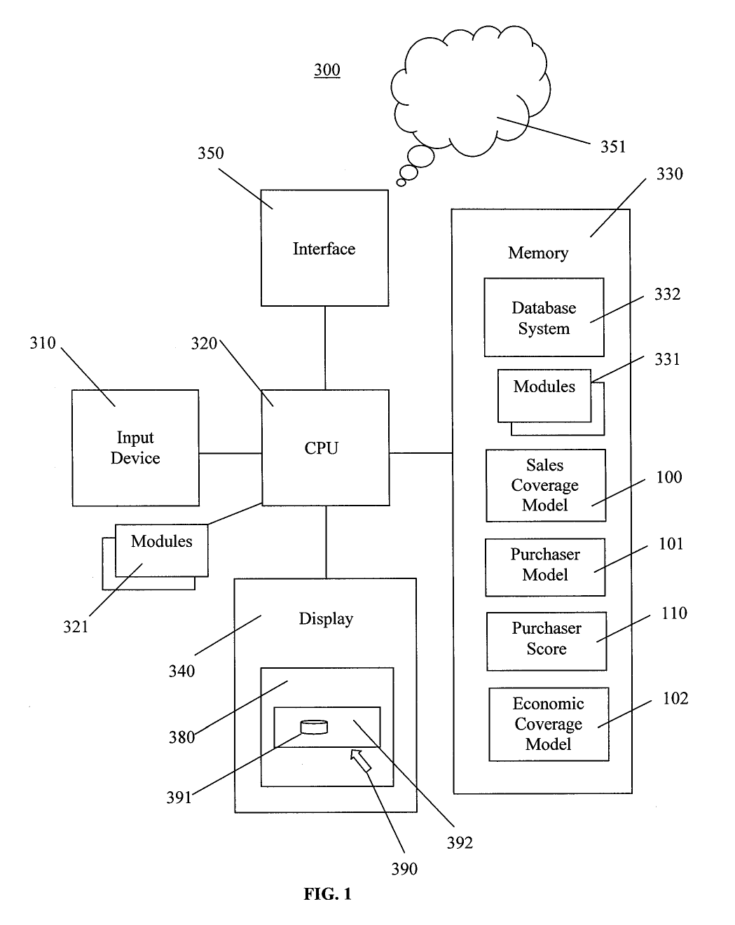

FIG. 1 is a block diagram illustrating a data processing system 300 in accordance with an embodiment of the invention. The data processing system 300 is suitable for generating a mutual fund sales coverage model. The data processing system 300 is also suitable for generating, displaying, and adjusting presentations in conjunction with a graphical user interface (“GUI”), as described below. The data processing system 300 may be a client and/or server in a client/server system. For example, the data processing system 300 may be a server system or a personal computer (“PC”) system. The data processing system 300 may also be a wireless device or other mobile, portable, or handheld device. The data processing system 300 includes an input device 310, a central processing unit (“CPU”) 320, memory 330, a display 340, and an interface device 350. The input device 310 may include a keyboard, a mouse, a trackball, a touch sensitive surface or screen, a position tracking device, an eye tracking device, or a similar device. The display 340 may include a computer screen, television screen, display screen, terminal device, a touch sensitive display surface or screen, or a hardcopy producing output device such as a printer or plotter. The memory 330 may include a variety of storage devices including internal memory and external mass storage typically arranged in a hierarchy of storage as understood by those skilled in the art. For example, the memory 330 may include databases, random access memory (“RAM”), read-only memory (“ROM”), flash memory, and/or disk devices. The interface device 350 may include one or more network connections. The data processing system 300 may be adapted for communicating with other data processing systems (e.g., similar to data processing system 300) over a network 351 via the interface device 350. For example, the interface device 350 may include an interface to a network 351 such as the Internet and/or another wired or wireless network (e.g., a wireless local area network (“WLAN”), a cellular telephone network, etc.). As such, the interface 350 may include suitable transmitters, receivers, antennae, etc. In addition, the data processing system 300 may include a Global Positioning System (“GPS”) receiver. Thus, the data processing system 300 may be linked to other data processing systems by the network 351. The CPU 320 may include or be operatively coupled to dedicated coprocessors, memory devices, or other hardware modules 321. The CPU 320 is operatively coupled to the memory 330 which stores an operating system (e.g., 331) for general management of the system 300. The CPU 320 is operatively coupled to the input device 310 for receiving user commands or queries and for displaying the results of these commands or queries to the user on the display 340. Commands and queries may also be received via the interface device 350 and results may be transmitted via the interface device 350. The data processing system 300 may include a database system 332 (or store) for storing data and programming information. The database system 332 may include a database management system (e.g., 332) and a database (e.g., 332) and may be stored in the memory 330 of the data processing system 300. In general, the data processing system 300 has stored therein data representing sequences of instructions which when executed cause the method described herein to be performed. Of course, the data processing system 300 may contain additional software and hardware a description of which is not necessary for understanding the invention.

Thus, the data processing system 300 includes computer executable programmed instructions for directing the system 300 to implement the embodiments of the present invention. The programmed instructions may be embodied in one or more hardware modules 321 or software modules 331 resident in the memory 330 of the data processing system 300 or elsewhere (e.g., 320). Alternatively, the programmed instructions may be embodied on a computer readable medium or product (e.g., a compact disk (“CD”), a floppy disk, etc.) which may be used for transporting the programmed instructions to the memory 330 of the data processing system 300. Alternatively, the programmed instructions may be embedded in a computer-readable signal or signal-bearing medium or product that is uploaded to a network 351 by a vendor or supplier of the programmed instructions, and this signal or signal-bearing medium may be downloaded through an interface (e.g., 350) to the data processing system 300 from the network 351 by end users or potential buyers.

A user may interact with the data processing system 300 and its hardware and software modules 321, 331 using a graphical user interface (“GUI”) 380. The GUI 380 may be used for monitoring, managing, and accessing the data processing system 300. GUIs are supported by common operating systems and provide a display format which enables a user to choose commands, execute application programs, manage computer files, and perform other functions by selecting pictorial representations known as icons, or items from a menu through use of an input device 310 such as a mouse. In general, a GUI is used to convey information to and receive commands from users and generally includes a variety of GUI objects or controls, including icons, toolbars, drop-down menus, text, dialog boxes, buttons, and the like. A user typically interacts with a GUI 380 presented on a display 340 by using an input device (e.g., a mouse) 310 to position a pointer or cursor 390 over an object (e.g., an icon) 391 and by “clicking” on the object 391. Typically, a GUI based system presents application, system status, and other information to the user in one or more “windows” appearing on the display 340. A window 392 is a more or less rectangular area within the display 340 in which a user may view an application or a document. Such a window 392 may be open, closed, displayed full screen, reduced to an icon, increased or reduced in size, or moved to different areas of the display 340. Multiple windows may be displayed simultaneously, such as: windows included within other windows, windows overlapping other windows, or windows tiled within the display area.

According to one embodiment, the present invention provides a method for building or generating a sales coverage model 100 for the mutual fund industry. As mentioned above, sales coverage pertains to allocating scarce sales resources to existing customers and prospective customers in order to maximize revenue and/or profit. In the mutual fund industry, the fund company's customers are financial advisors who buy funds on behalf of consumers. Contact channels typically used in the mutual fund industry include face-to-face meetings, telephone calls, direct mail, and email. The present invention includes a method for allocating coverage to existing advisors of the mutual fund company. The method may be extended to prospective advisors as well. The method uses several predictive models to generate the sales coverage model. The sales coverage model 100 is dynamic in that each month a coverage plan is recast for each financial advisor associated with the mutual fund company. According to one embodiment, the output of the sales coverage model 100 is a monthly file, report, or display containing the following data: unique identifier of the financial advisor; recommended number of sales contacts in the next 12 months and the recommended channels (e.g., 3 contacts comprising 1 meeting and 2 calls); recommended date of next contact; recommended contact channel of next contact; and, an optional cross sell message for the next contact.

According to one embodiment, the model 100 is generated based on the concept that each advisor has a response curve. In other words, the amount of each advisor's purchases from the mutual fund company is influenced by the amount of coverage effort that the mutual fund company makes. However, intuitively, there are diminishing returns associated with increasing amounts of coverage. There is also a real cost of coverage that needs to be justified by the returns. The method of the present invention estimates each advisor's response curve and then generates several coverage scenarios in order to choose the optimal scenario for each advisor. The final sales coverage model 100 or plan is then constrained by the actual resources available to the sales organization of the mutual fund company.

Accordingly to one embodiment, the first step in generating the sales coverage model 100 is to generate a purchaser model 101 by applying data mining models to mutual fund data stored in the memory 330, database 332, or database system 332 of the data processing system 300. The mutual fund data may include the following: (1) Sales and assets data (or “transactional data”) which consist of mutual funds purchased or redeemed by an advisor every month along with the assets; (2) Activity data including but not limited to calls, meetings, and presentations (or “coverage data”). Mutual fund companies' wholesalers and inside sales personnel get in touch with advisors via meetings, phone calls, and presentations to make sure that advisors purchase their mutual funds. These activities typically are logged into CRM systems. Information from this data is used to apply strategies on top of output generated by predictive analytics (i.e., data mining models and tools); and, (3) Other data including third party advisor data (such as Discovery™, RIADatabase™, and Meridian-IQ™) and marketing data. Such data vendors collect data about advisors which includes a wide range of information such as the firm they work for, licenses that they hold, type of advisor, etc. This information combined with sales and assets data is used to predict which advisor is likely to purchase from the mutual fund company.

The purpose of the purchaser model 101 is to rank advisors each month based on the purchase amount (i.e., dollars) they are predicted to make in the following month. These scores guide salespeople to concentrate their efforts on advisors who are most ready to buy. Using data mining software 331 such as Angoss KnowledgeSTUDIO™ available from Angoss Software Corporation, the modelling process may include the following steps.

First, perform the following exemplary query to generate results ready for graphing using spreadsheet software such as Excel™. Use this to find representative months to create the mining views for the model. If there is nothing exceptional about recent months, then the most recent months should be used.

```
drop table #monthly_results
SELECT TIME_ID
  ,SUM(PURCHASES) AS PURCHASES
  ,SUM(REDEMPTIONS) AS REDEMPTIONS
into #monthly_results
FROM FG_MEASURES_ROLLDOWN M
WHERE TIME_ID >= . . .
GROUP BY TIME_ID
SELECT time_ID
  ,purchases
  ,redemptions
  ,( purchases - redemptions ) AS net
FROM #monthly_results
ORDER BY time_ID
```

Request the mining views from the data manager module of the data mining software 331. Two mining views will be required, usually from two consecutive months.

Second, with the mining views provided, perform queries to check the number of advisors and quantities such as purchase dollars and independently check them against the results in the original FG_MEASURES tables. Also check the number of records containing null data, such as nulls in the assets0 column. If need be, this exploratory analysis can be performed within Angoss KnowledgeSTUDIO 331 using the dataset overview report and dataset chart functionality.

Third, evaluate the definition of the dependent variable. Normally the dependent variable will be based on the pattern “sales in the following month>=$10,000”, but the choice of threshold is dependent on the data. The goal is to have between 5 and 10% of the advisors in the sample passing this threshold. The definition of the dependent variable will need to be coded within the dataset as a binary flag, with 1 indicating that the advisor is a heavy purchaser and 0 otherwise. Name this variable “DV_purchaser_flag”.

Fourth, create the development and validation datasets. Create one dataset from the newest mining view and name it “original_mining_view name_DEV” and a second dataset from the earlier mining view named “original_mining_view_name_VAL”.

Fifth, open Angoss KnowledgeSTUDIO 331 and change the working directory to point to the “Data mining” folder of a project directory. If it does not exist already, create an Angoss KnowledgeSTUDIO project called, for example, “FundGUARD models” within the “Data mining” folder. Click on this project.

Sixth, now follow the menu in Angoss KnowledgeSTUDIO 331 to insert both datasets from, for example, SQL Server™.

Seventh, build an initial exploratory model using decision trees. Using the development dataset, in Angoss KnowledgeSTUDIO 331 follow the commands to insert a decision tree named “original_mining_view_name_DEV_decisiontree1”. The default settings can be used (i.e., cluster search method, split on entropy variance, etc.). On the split report dialog, exclude any variables that are related to the dependent variable (i.e., those variables containing the suffix NP_{—}1). Then select the default settings to automatically grow the tree. Visually inspect the resulting tree presented on the display 340 of the data processing system 300.

Eighth, build the final logistic model. Using the development dataset, in Angoss KnowledgeSTUDIO 331 follow the commands to insert a predictive model of type logistic named “original_mining_view_name_DEV_LogR1” based on the template model “original_mining_view_name_DEV_{—decisiontree}1”. Follow all the default settings for the stepwise logistic model. Visually inspect the resulting model as presented on the display 340 of the data processing system 300. The model should contain between five and ten variables.

Ninth, score the validation dataset. Follow the menu in Angoss KnowledgeSTUDIO 331 to score the dataset “original_mining_view_name_VAL” using the logistic model and name the score “DV purchaser1 yes prob”.

Tenth, evaluate the model on the independent validation dataset. Follow the menu in Angoss KnowledgeSTUDIO 331 to insert a model analyzer named “Analyzer1 on VAL”. Choose discrete variable, the dataset “original_mining_view_name_VAL”, known outcome “DV_purchaser_flag”, known outcome value 1. The model analyzer will produce validation statistics for the model, including a cumulative lift chart and ROC chart. Visually inspect the results as presented on the display 340 of the data processing system 300. If in doubt, the validation dataset can be scored and evaluated on the tree model as well. Performance of the two models should be comparable.

Eleventh, within the project folder, Angoss KnowledgeSTUDIO 331 produces a .kdm model file called “original_mining_view_name_DEV_{—LogR}1.kdm”. This file needs to be handed over to the implementation manager.

Twelfth, build a strategy tree to illustrate usage of the model. The validation dataset, which contains scored records, can be used to perform calculations and assign treatments to groups of advisors based on custom business rules. Follow the menu in Angoss Knowledge STUDIO 331 to insert a strategy tree named “original_mining_view_name_VAL_strategytree”. Steps thereafter may be customized for each mutual fund company.

The outcome of the above data mining analysis is a purchaser model 101 that assigns a purchaser score 110 to each purchaser.

The second step in generating the sales coverage model 100 is to generate a response curve 120 using the purchaser score 110 from the purchaser model 101 and additional inputs as described below. Note that the data used throughout the analysis consists of at least three years of both transactional and coverage data for the mutual fund company.

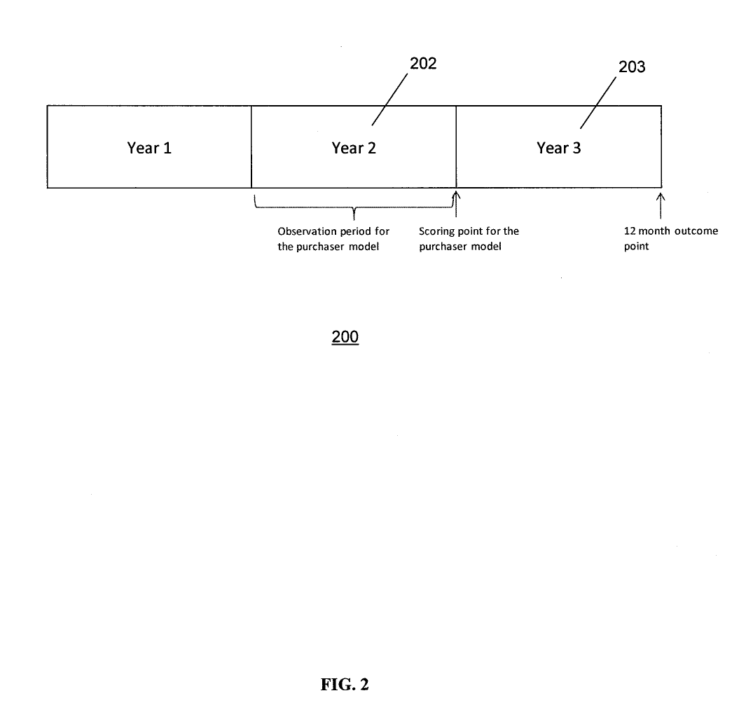

FIG. 2 is a block diagram illustrating timing 200 for a first stage response curve in accordance with an embodiment of the invention. In building a response curve 120 for an advisor, the aim is to predict the advisor's mutual fund purchases in year 3 203. The response curve 120 may be built in three stages according to one embodiment. The first stage uses the purchaser score 110 from the purchaser model 101 as the sole predictor. The purchaser model 101 has been built to predict purchases over the next 30 days but, in practice, it has been found to be an excellent predictor of the next year. The steps for building the purchaser model 101 are described above.

The first stage model (or curve) is may be expressed as follows:

[Purchases in next 12 month]=β0+β1 [Purchaser score]

The model may be fitted using linear regression in Angoss KnowledgeSTUDIO 331, and this generates the coefficients (i.e., betas β0, β1 for the model.

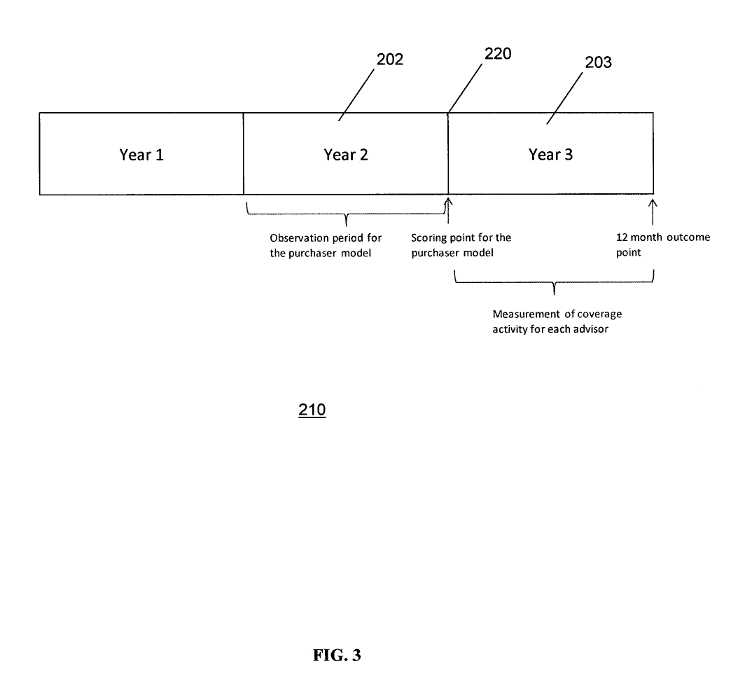

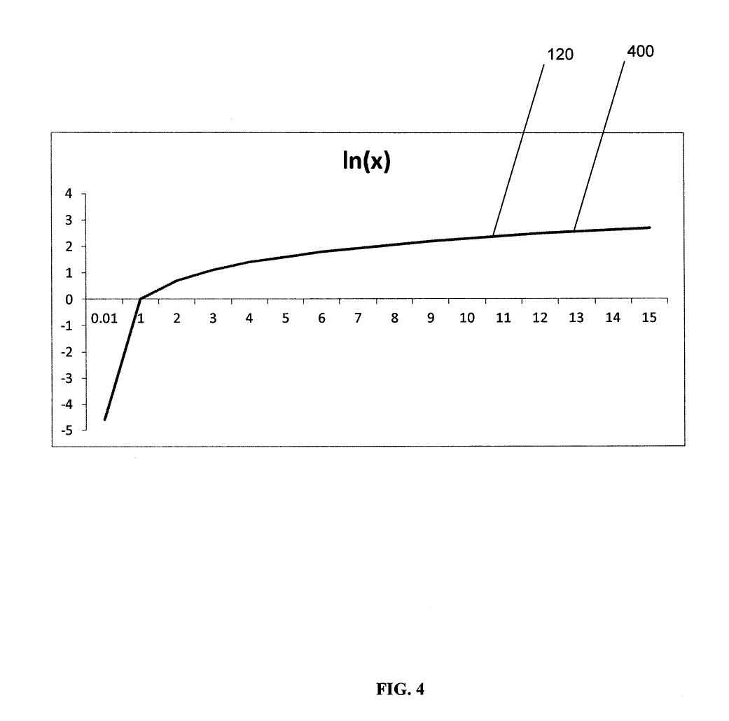

FIG. 3 is a block diagram illustrating timing 210 for a second stage response curve 400 in accordance with an embodiment of the invention. And, FIG. 4 is a graph illustrating an exemplary second stage response curve 400 in accordance with an embodiment of the invention. The second stage response curve 400 uses the purchaser score 110 and coverage data. The second stage response curve 400 is a refinement of the first stage curve in that it also includes coverage activity, based on the concept that coverage activity modifies the outcome predicted by the purchaser model 101. This makes it a true response curve, rather than just a prediction. The coverage activity is taken from year 3 203, which is the outcome period (response period) that the method is modelling for. In a traditional predictive model, one would not allow themselves to include this data, since one would then be using information that would not be known at the point of scoring 220. However, the present method uses this data to generate what-if scenarios.

The second stage model (or curve 400) may be expressed as follows:

[Purchases in next 12 month]=β0+β1 [Purchaser score]+β2*ln(number of meetings per year)+β3*ln(number of phone calls per year)

The model may be fitted using linear regression in Angoss KnowledgeSTUDIO 331, and this generates the coefficients (i.e., betas β0, β1, β2, β3) for the model. These coefficients are not the same as in the first stage model. In the second stage model, the coverage terms are transformed using a natural log function, ln(x). This function captures the observed behaviour that there are positive, but diminishing returns, associated with increasing amounts of coverage.

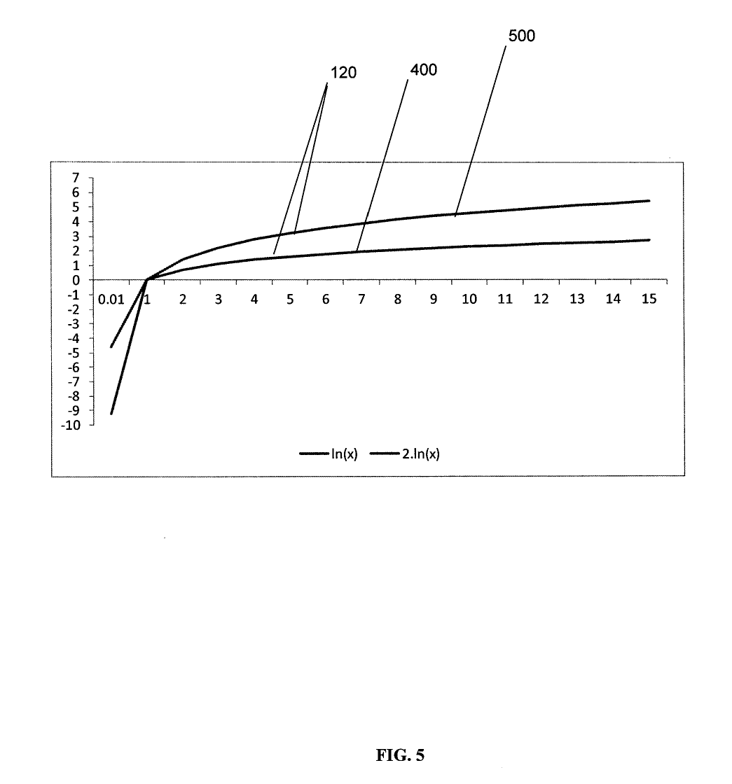

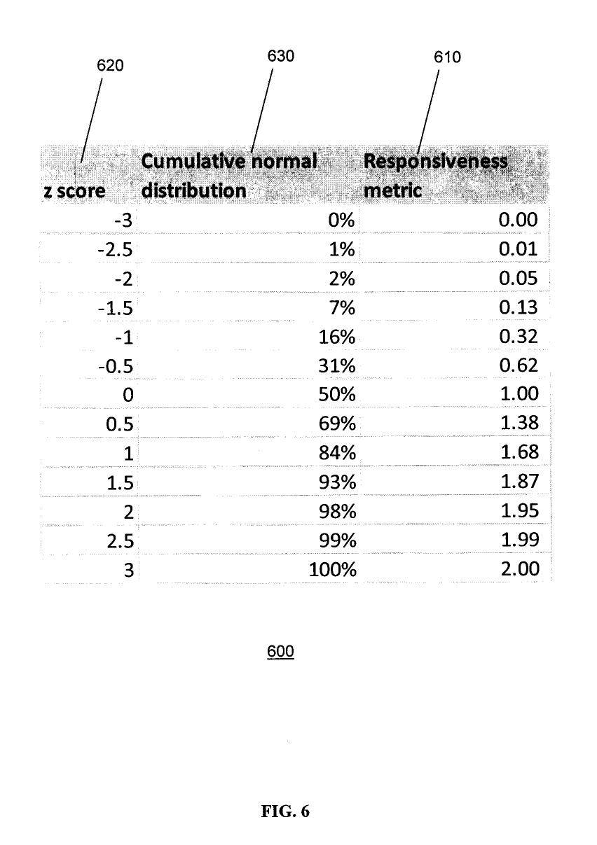

FIG. 5 is a graph illustrating an exemplary third stage response curve 500 in accordance with an embodiment of the invention. And, FIG. 6 is a table 600 listing exemplary responsiveness metrics 610 in accordance with an embodiment of the invention. The third stage response curve 500 is a refinement of the second stage curve 400 in that it also includes advisor responsiveness data. The third stage model is an optional refinement to the second stage model and is dependent on data availability, and the improvement that this model achieves over the second stage model. The concept behind the third stage model is that some advisors are simply more responsive to coverage than others, that is, their responsiveness slope is higher. The second stage model estimates the impact of coverage on advisors who have similar purchaser scores 110, but this result may de-averaged by including an advisor level responsiveness metric 610 which will either boost or dampen the prediction. FIG. 5 shows how multiplying the natural log term by a factor of 2 would impact the curve.

The third stage model (or curve 500) may be expressed as follows:

[Purchases in next 12 month]=β0+β1 [Purchaser score]+β2*(Responsiveness)*ln(number of meetings per year)+β3*(Responsiveness)*ln(number of phone calls per year)

The model may be fitted using linear regression in Angoss KnowledgeSTUDIO 331, and this generates the coefficients (i.e., betas β0, β1, β2, β3) for the model. These coefficients are not the same as in the earlier models. The responsiveness metric 610 is designed so that in the average case the response curve will be identical to that of the second stage model. The responsiveness metric 610 is obtained by applying the second stage model to year 1 transactions and year 2 coverage activities, that is, it is a value that is known at the scoring point 220 at the end of year 2 202. Then, for each advisor, the residual error is calculated as follows:

[Residual error]=[Actual purchases in year 2]−[Predicted purchases in year 2]

Each residual error is transformed into a z score 620 by subtracting the mean residual error and dividing by the standard deviation. The z score 620 can be interpreted as how many standard deviations the observation is from the mean. Finally, the z score 620 is transformed into a value 610 that ranges between 0 and 2, by dividing the cumulative normal percentage 630 by its mean (0.5) as per the table 600 shown in FIG. 6. If an advisor has insufficient history to enable the responsiveness metric 610 to be calculated, then a value of 1 is assigned.

So, for an advisor whose predicted purchases were much higher than the actual in year 2 202, their responsiveness metric 610 will be less than 1 and this will have a dampening effect. For an advisor whose predicted purchases were much lower than actuals, their responsiveness metric 610 will be greater than 1 and that will have a boosting effect. Responsiveness 610 is constrained to take values between 0 and 2.

The third step in generating the sales coverage model 100 is to generate an economic coverage model 102 for each month. At this point, each advisor now has a response curve 120. In other words, for each advisor, their predicted revenue may be generated under scenarios when (Number of meetings, Number of phone calls) takes on the values (0,0), (1,0), (1,1), (2,1), and so on. During the scoring month, for each advisor, the purchaser score 110 is updated using the transactional data from the last year. The responsiveness metric 610 is also updated using data from the last two years. These values are inserted into the third stage model 500 across a set of scenarios ranging from 0 to 12 meetings and 0 to 12 calls. It follows that 13²=169 scenarios are generated for each advisor. Each scenario is evaluated economically as follows:

[Profit]=[Margin]*[Predicted purchase dollars]−[Coverage expense]=[Margin]*[Predicted purchase dollars]−[Number of meetings]*[Cost per meeting]−[Number of phone calls]*[Cost per phone call]

Most mutual fund companies will have these numbers on hand, and a typical equation for the industry would be as follows:

[Profit]=0.01*[Predicted purchase dollars]−[Number of meetings]*$500−[Number of phone calls]*$50

The best scenario is then chosen for each advisor and this set of scenarios can be viewed as an initial coverage plan or model 100. It may be presented on the display screen 340 of the system 300. The initial coverage plan is then tuned to generate the monthly coverage plan. The initial coverage plan is tuned to the realities of sales resourcing at this step as follows.

First, when there is a fixed sales budget of $X, the advisors' best scenarios are sorted in descending order of profitability. Moving down the list, once the sales budget is exhausted, all scenarios below this line are reduced to (Number of meetings, Number of phone calls)=(0,0) and recalculated.

Second, when there is a fixed number of meetings and phone calls, the advisors' best scenarios are sorted in descending order of profitability. Moving down the list, once one of the constraints (say, meetings) is breached, the advisors below this line are sent for re-evaluation. To do this, just the 13 scenarios for each advisor are retained where meetings=0 and a new best scenario is chosen for each advisor. These advisors' best scenarios are sorted in descending order of profitability and once the second constraint (phone calls) is breached, all scenarios below this line are reduced to (Number of meetings, Number of phone calls)=(0,0) and recalculated.

Third, when there is a desired expense to revenue ratio, the expense to revenue ratio being the coverage expense divided by the revenue, the advisors' best scenarios are taken and the overall expense to revenue ratio is calculated. If this exceeds the target, then the advisors' best scenarios are sorted in descending order of profitability and the bottom scenario is reduced to (Number of meetings, Number of phone calls)=(0,0) and recalculated. This process is repeated until the desired expense to revenue ratio is achieved.

From the above, the recommended number of sales contacts in the next 12 months and the recommended channels (e.g., 3 contacts comprising 1 meeting and 2 calls) for each advisor may be provided as the sales coverage plan or model 100. These results may be presented on the display 340 of the system 300.

The recommended date of next contact may now be determined as follows. The recommended number of contacts in 12 months is divided into 360 to obtain the ideal number of days between contacts. This number is added to the date of the last coverage event to obtain the schedule for the next contact. The recommended contact channel of next contact may also be determined as follows. If the recommended number of contacts in 12 months is n, then the last (n−1) contacts are obtained and the next contact is chosen to most closely meet the recommended channel mix. Finally, an optional cross sell message for the next contact may be obtained directly from a cross sell model. These results may be presented on the display 340 of the system 300.

The sales coverage model 100 is a practitioner's model and as such it includes a number of compromises including the following: (1) The coverage patterns in year 3 203 are not from an experimental (randomized) design, but from real-world data. Existing coverage patterns will contain the biases of the sales force; (2) In addition, coverage activities are not necessarily evenly spaced during the year, they can bunch. The impact of this is ignored; (3) In year 3 203, purchases can occur before coverage and vice versa. The outcome period (response period) of a year is deemed long enough though to enable the association of results with coverage at the aggregate level; (4) In reality, not all advisors will be contactable. At the same time, a number of contacts will be made outside of the plan. It is assumed that these behaviours cancel each other out; and, (5) A distinction between gross purchases and net purchases (purchases net of redemptions) has not been made.

The above embodiments may contribute to an improved method for generating a mutual fund sales coverage model 100 and may provide one or more advantages. First, the method employs data mining techniques to determine a purchaser score 110. Second, the method employs a responsiveness metric 610 to modify the response curve 120, 500 used to predict purchase amounts.

Aspects of the above described method may be summarized with the aid of a flowchart.

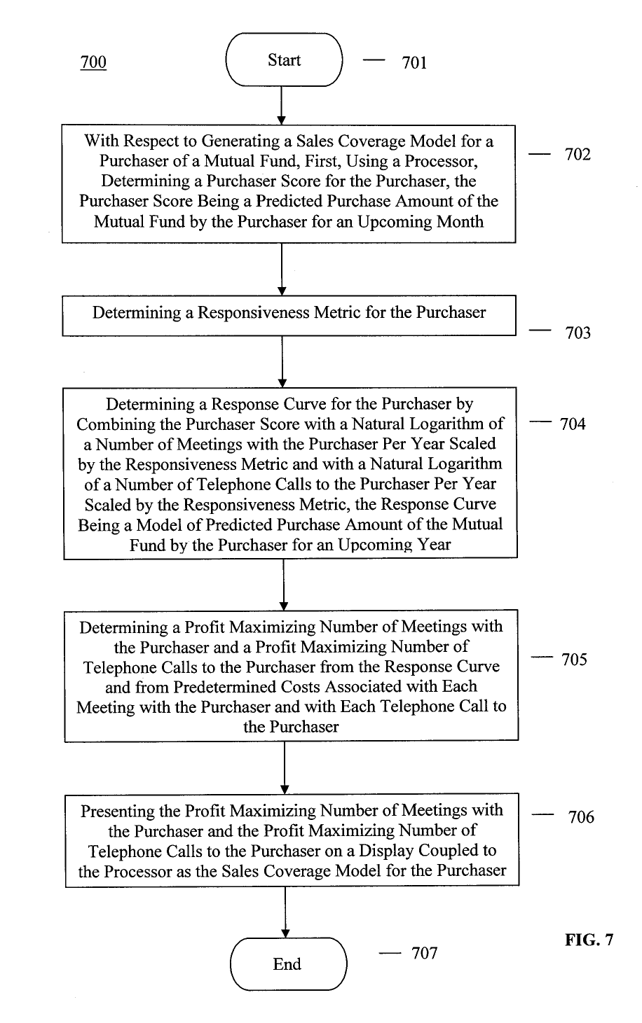

FIG. 7 is a flow chart illustrating operations 700 of modules 321, 331 within a data processing system (e.g., 300) for generating a sales coverage model 100 for a purchaser of a mutual fund, in accordance with an embodiment of the invention.

At step 701, the operations 700 start.

At step 702, using a processor 320, a purchaser score 110 for the purchaser is determined, the purchaser score 110 being a predicted purchase amount of the mutual fund by the purchaser for an upcoming month (or year).

At step 703, a responsiveness metric 610 for the purchaser is determined.

At step 704, a response curve 120 for the purchaser is determined by combining the purchaser score 110 with a natural logarithm of a number of meetings with the purchaser per year scaled by the responsiveness metric 610 and with a natural logarithm of a number of telephone calls to the purchaser per year scaled by the responsiveness metric 610, the response curve 120 being a model of predicted purchase amount of the mutual fund by the purchaser for an upcoming year.

At step 705, a profit maximizing number of meetings with the purchaser and a profit maximizing number of telephone calls to the purchaser is determined from the response curve 120 and from predetermined costs (e.g., 102) associated with each meeting with the purchaser and with each telephone call to the purchaser.

At step 706, the profit maximizing number of meetings with the purchaser and the profit maximizing number of telephone calls to the purchaser is presented on a display 340 coupled to the processor 320 as the sales coverage model 100 for the purchaser.

At step 707, the operations 700 end.

In the above method, the purchaser may be a financial advisor who purchases the mutual fund on behalf of consumers. The purchaser score 110 may be determined from a purchaser model 101 by applying one or more data mining models to mutual fund data. The mutual fund data may include one or more of transactional data, coverage data, third party advisor data, and marking data. The purchaser model 101 may rank the purchaser based on the predicted purchase amount using the purchaser score 110. And, the responsiveness metric 610 may modify the response curve 120 to adjust for differences between predicted purchase amounts and actual purchase amounts.

According to one embodiment, each of the above steps 701-707 may be implemented by a respective software module 331. According to another embodiment, each of the above steps 701-707 may be implemented by a respective hardware module 321. According to another embodiment, each of the above steps 701-707 may be implemented by a combination of software 331 and hardware modules 321.

While this invention is primarily discussed as a method, a person of ordinary skill in the art will understand that the apparatus discussed above with reference to a data processing system 300 may be programmed to enable the practice of the method of the invention. Moreover, an article of manufacture for use with a data processing system 300, such as a pre-recorded storage device or other similar computer readable medium or product including program instructions recorded thereon, may direct the data processing system 300 to facilitate the practice of the method of the invention. It is understood that such apparatus and articles of manufacture also come within the scope of the invention.

In particular, the sequences of instructions which when executed cause the method described herein to be performed by the data processing system 300 can be contained in a data carrier product according to one embodiment of the invention. This data carrier product can be loaded into and run by the data processing system 300. In addition, the sequences of instructions which when executed cause the method described herein to be performed by the data processing system 300 can be contained in a computer program or software product according to one embodiment of the invention. This computer program or software product can be loaded into and run by the data processing system 300. Moreover, the sequences of instructions which when executed cause the method described herein to be performed by the data processing system 300 can be contained in an integrated circuit product (e.g., a hardware module or modules 321) which may include a coprocessor or memory according to one embodiment of the invention. This integrated circuit product can be installed in the data processing system 300.

The embodiments of the invention described above are intended to be exemplary only. Those skilled in the art will understand that various modifications of detail may be made to these embodiments, all of which come within the scope of the invention.

What is claimed is:

1. A method for generating a sales coverage model for a purchaser of a mutual fund, comprising:
using a processor, determining a purchaser score for the purchaser, the purchaser score being a predicted purchase amount of the mutual fund by the purchaser for an upcoming month;
determining a responsiveness metric for the purchaser;
determining a response curve for the purchaser by combining the purchaser score with a natural logarithm of a number of meetings with the purchaser per year scaled by the responsiveness metric and with a natural logarithm of a number of telephone calls to the purchaser per year scaled by the responsiveness metric, the response curve being a model of predicted purchase amount of the mutual fund by the purchaser for an upcoming year;
determining a profit maximizing number of meetings with the purchaser and a profit maximizing number of telephone calls to the purchaser from the response curve and from predetermined costs associated with each meeting with the purchaser and with each telephone call to the purchaser; and,
presenting the profit maximizing number of meetings with the purchaser and the profit maximizing number of telephone calls to the purchaser on a display coupled to the processor as the sales coverage model for the purchaser.

2. The method of claim 1 wherein the purchaser is a financial advisor who purchases the mutual fund on behalf of consumers.

3. The method of claim 1 wherein the purchaser score is determined from a purchaser model by applying one or more data mining models to mutual fund data.

4. The method of claim 3 wherein the mutual fund data includes one or more of transactional data, coverage data, third party advisor data, and marking data.

5. The method of claim 3 wherein the purchaser model ranks the purchaser based on the predicted purchase amount using the purchaser score.

6. The method of claim 1 wherein the responsiveness metric modifies the response curve to adjust for differences between predicted purchase amounts and actual purchase amounts.

7. A system for generating a sales coverage model for a purchaser of a mutual fund, comprising:
a processor coupled to memory and a display; and,
at least one of hardware and software modules within the memory and controlled or executed by the processor, the modules including:
a module for determining a purchaser score for the purchaser, the purchaser score being a predicted purchase amount of the mutual fund by the purchaser for an upcoming month;
a module for determining a responsiveness metric for the purchaser;
a module for determining a response curve for the purchaser by combining the purchaser score with a natural logarithm of a number of meetings with the purchaser per year scaled by the responsiveness metric and with a natural logarithm of a number of telephone calls to the purchaser per year scaled by the responsiveness metric, the response curve being a model of predicted purchase amount of the mutual fund by the purchaser for an upcoming year;
a module for determining a profit maximizing number of meetings with the purchaser and a profit maximizing number of telephone calls to the purchaser from the response curve and from predetermined costs associated with each meeting with the purchaser and with each telephone call to the purchaser; and,
a module for presenting the profit maximizing number of meetings with the purchaser and the profit maximizing number of telephone calls to the purchaser on the display as the sales coverage model for the purchaser.

8. The system of claim 7 wherein the purchaser is a financial advisor who purchases the mutual fund on behalf of consumers.

9. The system of claim 7 wherein the purchaser score is determined from a purchaser model by applying one or more data mining models to mutual fund data.

10. The system of claim 9 wherein the mutual fund data includes one or more of transactional data, coverage data, third party advisor data, and marking data.

11. The system of claim 9 wherein the purchaser model ranks the purchaser based on the predicted purchase amount using the purchaser score.

12. The system of claim 7 wherein the responsiveness metric modifies the response curve to adjust for differences between predicted purchase amounts and actual purchase amounts.
